(19) United States
(12) Patent Application Publication
(10) Pub. No.: US 2009/0294073 A1
(43) Pub. Date: Dec. 3, 2009

(54) SUBSTRATE PROCESSING APPARATUS

(76) Inventors: Yoji Takizawa, Kanagawa (JP); Hisashi Nishigaki, Kanagawa (JP)

Correspondence Address: SNELL & WILMER LLP (OC), 600 ANTON BOULEVARD, SUITE 1400, COSTA MESA, CA, 92626, US

(21) Appl. No.: 11/997,284

(22) PCT Filed: Feb. 22, 2007
(86) PCT No.: PCT/JP2007/053260

§ 371 Date: Jun. 16, 2009

(30) Foreign Application Priority Data
Mar. 1, 2006 (JP) 2006-055278

(51) Int. Cl. B29C 65/00; B32B 37/00

(52) U.S. Cl. 156/498; 156/538

(57) ABSTRACT

To provide a substrate processing apparatus capable of uniformly processing substrates without applying excessive force to the substrates and without being affected by the standing time. The substrate processing apparatus includes a holding portion 2 that holds the substrate 1 after molding, and a flow rectification portion 3 disposed near the substrate 1 that is held by the holding portion 2. The flow rectification portion 3 includes a facing portion 33 opposed to and near to one side of the substrate 1, an inlet portion 32 for introducing cooling gas G between the facing surface 33 and the substrate 1, and a drive unit that rotates the facing portion 33. Fins 34 are formed in the facing portion 33.

### TECHNICAL FIELD

The present invention relates to a substrate processing apparatus that processes molded substrates for manufacturing flat plate shaped recording media, such as for example optical discs.

### BACKGROUND ART

Disc-shaped recording media in a format that can be read optically, such as optical discs or optomagnetic discs are widely used, not just discs for replay only, but also discs in which the recorded information can be overwritten. This recording medium is manufactured by bonding substrates together, in order to protect the recording surface formed on a substrate, and in order to achieve high density recording by lamination with several layers on the recording surface.

The manufacture of this type of recording medium is carried out as follows, for example. Two sheets of polycarbonate substrate are formed by injection molding, and a metal film is formed on them by sputtering in a sputtering chamber. Then an ultraviolet hardening adhesive is applied to the joint surfaces of the two sheets of substrate by spin coating. The pair of substrates to which adhesive has been applied are inserted in a vacuum chamber, and the two surfaces with adhesive are bonded together in a vacuum. The bonded substrates are taken from the vacuum chamber to atmospheric pressure, and the adhesive is hardened by irradiating it with ultraviolet light. In this way, the two substrates are strongly bonded, and the disc is completed.

However, if there is twisting or bending or the like in the substrates before bonding, the thickness of the adhesive layer manufactured as described above will not be uniform. Therefore when a laser that is used for reading the information illuminates the disc, there is the possibility that the required position on the recording surface will not be accurately reached. Therefore, it is important for obtaining stable quality of products to remove any bending or twisting or the like from the substrates from the discs after forming.

For example, continuously injection molded substrates are at a high temperature immediately after molding, so they are easily deformed. Therefore, deformation can be minimized by allowing the substrate to stand for a certain period of time before carrying out the subsequent processes to form the adhesive layer by spin coating. However, there is a certain amount of variation in the temperature of each substrate, so it is not possible to obtain the ideal amount of standing time, and as a result the yield rate of the final product is reduced.

To remedy this, technology has been proposed for forcibly cooling a plurality of substrates using an air flow, as disclosed in Patent Document 1, and technology for efficiently cooling by rotating the substrates together with using an air flow, as disclosed in Patent Document 2.

Patent Document 1: Japanese Patent Application Laid-open No. 2000-137931

Patent Document 2: Japanese Patent Application Laid-open No. H5-109126

However, in cooling with simply an air flow, the air is not uniformly applied to each substrate, and the result is variation in the temperature. Also, in the method of rotating the substrates, excessive forces can be applied to the substrates due to centrifugal action or shaking of the core, which could lead to deformation, and affect the tilt.

### DISCLOSURE OF THE INVENTION

The present invention has been proposed to solve the above problem points of conventional art, and it is an object of the present invention to provide a substrate processing apparatus capable of uniformly processing substrates without applying excessive force to the substrates, and without being affected by the standing time.

To achieve the above object, the present invention includes a holding portion that holds a substrate; and a flow rectification portion disposed near the substrate that is held by the holding portion, wherein the flow rectification portion has a facing portion opposed to and close to at least one side of the substrate, and an inlet portion that introduces a medium for processing between the substrate, which is held by the holding portion, so as to not rotate and the facing portion.

In the invention as described above, the substrate is efficiently processed by passing a medium introduced from the inlet portion between the substrate, which is held so as not to rotate, and the facing portion near the substrate.

In another form, the flow rectification portion has a drive unit that rotates the facing portion.

In the form as described above, it is possible to make the processing medium pass uniformly over the surface of the substrate.

In another form, projections or grooves are formed in the facing portion.

In the form as described above, processing with good efficiency is possible by promoting the flow of the medium by the projections or grooves in the facing portion.

In another form, the facing portion is disposed on both sides of the substrate.

In the form as described above, by processing the substrate from both sides, it is possible to uniformly process the substrate in a shorter time.

In another form, the facing portion is provided with a projecting portion near the peripheral edge of the substrate to narrow the gap with the substrate.

In the form as described above, the flow speed of the medium introduced between the facing portion and the substrate is increased at the location where the gap with the substrate is narrowed by the projection, which promotes the process.

In another form, a cooling device is provided on the flow rectification portion to cool the facing portion.

In the form as described above, the facing portion is cooled, so the cooling performance is increased, and more uniform cooling is possible.

In another form, a heating device is provided on the flow rectification portion to heat the facing portion.

In the form as described above, the facing portion is heated, so the heating performance is increased, and more uniform heating is possible. In particular, when drying substances applied to the substrate, deformation of the substrate is prevented, and it is possible to achieve uniform processing and shorter drying time.

According to the present invention as described above, it is possible to provide a substrate processing apparatus capable of uniformly processing substrates without applying excessive force to the substrates, and without being affected by the standing time.

### BRIEF DESCRIPTION OF THE DRAWINGS

FIG. 1 is a vertical section showing an embodiment according to the present invention;

FIG. 2 is a bottom view showing the facing portion of the embodiment in FIG. 1;

FIG. 3 is a vertical section showing an example of the layout of a cooling chamber of the embodiment in FIG. 1;

FIG. 4 is a vertical section showing another embodiment (a layout in which there is a facing portion on both sides of the substrate) according to the present invention;

FIG. 5 is a vertical section showing another embodiment (a projection is formed in the facing portion) according to the present invention;

FIG. 6 is a front view showing another embodiment (facing portions are arranged on a turntable) according to the present invention;

FIG. 7 is a side view of FIG. 6;

FIG. 8 is a vertical section showing the fins in the facing portion of another embodiment according to the present invention; and

FIG. 9 is a vertical section showing another embodiment (cooling device disposed on the facing portion) according to the present invention.

### BEST MODE FOR CARRYING OUT THE INVENTION

Next, the best modes for carrying out the invention (hereafter referred to as “embodiments”) are specifically explained with reference to the drawings.

### Configuration

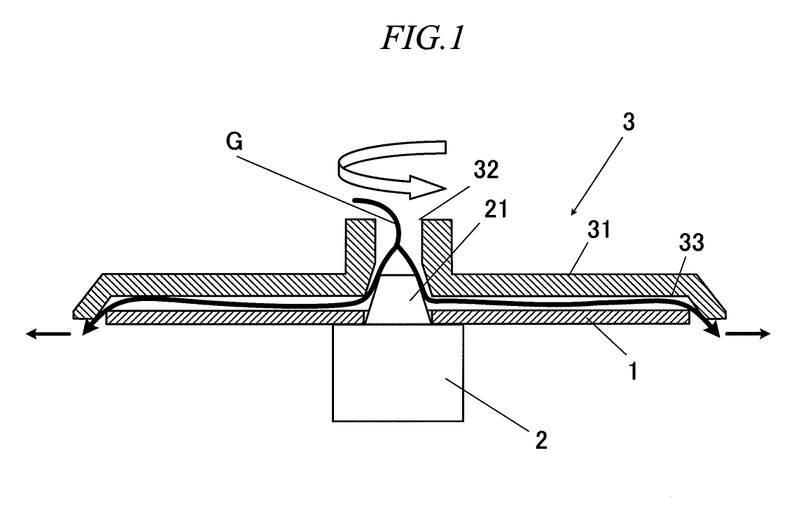

First, the configuration of the present embodiment is explained with reference to FIGS. 1 through 3. The present embodiment is a device for cooling and hardening injection molded substrates, and commonly known technology for injection molding machines and for transport devices for feeding in and feeding out substrates can be applied, so their explanation is omitted.

The present embodiment includes, as shown in FIG. 1, a holding portion 2 on which substrates 1 are loaded, and a flow rectification portion 3 disposed close to the substrate 1. The holding portion 2 is means for loading substrates 1 after injection molding, and includes a pin 21 that holds substrates 1 by being inserted into a center hole of the substrates 1.

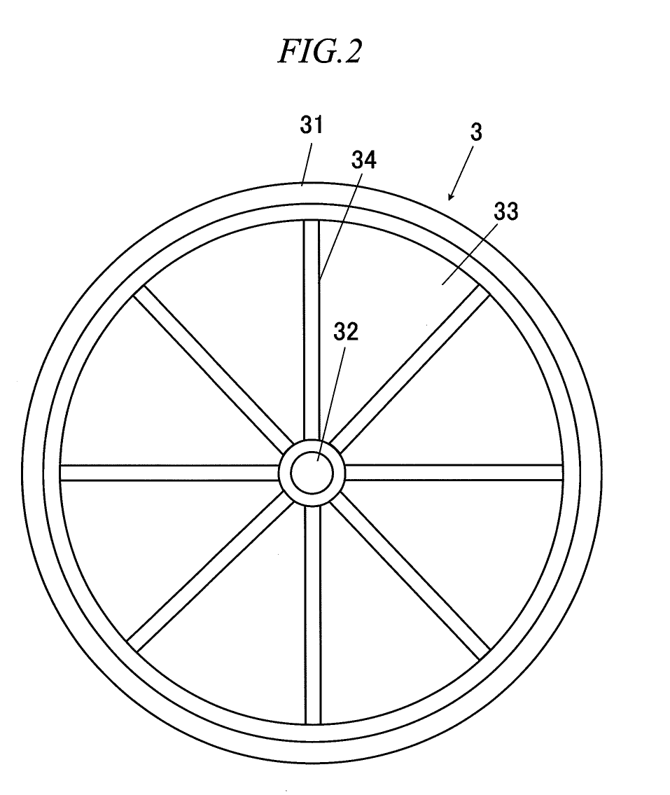

The flow rectification portion 3 includes a rotatable plate 31, and a drive unit (not shown in the drawings) that rotates the plate 31. The plate 31 includes an inlet portion 32 through which cooling gas G is introduced, and a facing portion 33 that is in opposition to one side of the substrate 1 so as to cover the side of the substrate 1. As shown in FIG. 2, the facing portion 33 includes raised fins 34 in a radiating form on a flat surface.

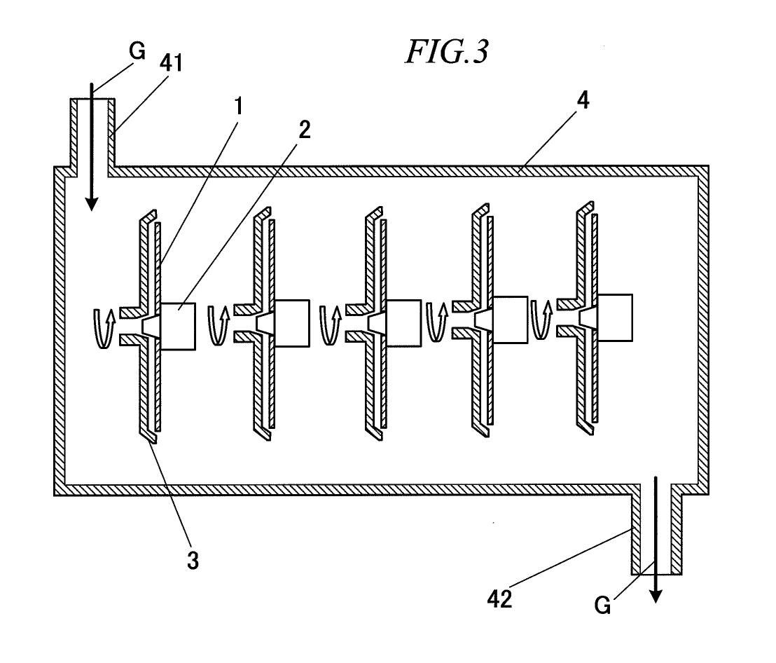

As shown in FIG. 3, a plurality of the holding portions 2 and the flow rectification portions 3 are arranged in parallel within a cooling chamber 4, so that the rotational axis of the plate 31 is horizontal. The cooling chamber 4 includes a gas supply unit 41 connected to a source of cooling gas (which is not shown in the drawings), and a gas discharge unit 42 for discharging the cooling gas G.

### Operation

The following is an explanation of the operation of the present embodiment configured as described above. Substrates 1 that have been molded in an injection molding machine and transported by a transport device are introduced into the cooling chamber 4 and held by the holding portion 2 by inserting the pin 21 into the center hole of the substrate 1. Cooling gas G is supplied into the cooling chamber 4 from the gas supply unit 41, and the plate 31 is rotated by the drive unit.

Then, as shown in FIG. 1, cooling gas G flows into the inlet portion 32, and the cooling gas G flows along the surface of the substrate 1 from the center to the outside. This flow is uniform between the facing portion 33 of the plate 31 that is close to the substrate 1, so the substrate 1 is uniformly cooled.

### Effect

According to the embodiment as described above, cooling is carried out not by simply blowing external gas, but cooling gas G is made to flow along each substrate 1 by the plate 31, so the substrate 1 is uniformly cooled. In particular, the plate 31 on which the fins 34 are formed rotates, so it is possible to uniformly pass the cooling gas G over the surface of the substrate 1. Further, uniform forced cooling is carried out for each substrate 1, so the variation due to the standing time does not occur.

In this way it is possible to continuously cool a plurality of substrates 1 to a predetermined temperature, so that there is no effect due to the thickness of the adhesive layer after bonding, and the yield rate is improved. Also, the area for an extended transport path to ensure the standing time is not necessary, so it is possible to achieve a smaller apparatus overall. Further, the substrates 1 themselves are not rotated, so tilting due to deformation of the substrate 1 is prevented.

### OTHER EMBODIMENTS

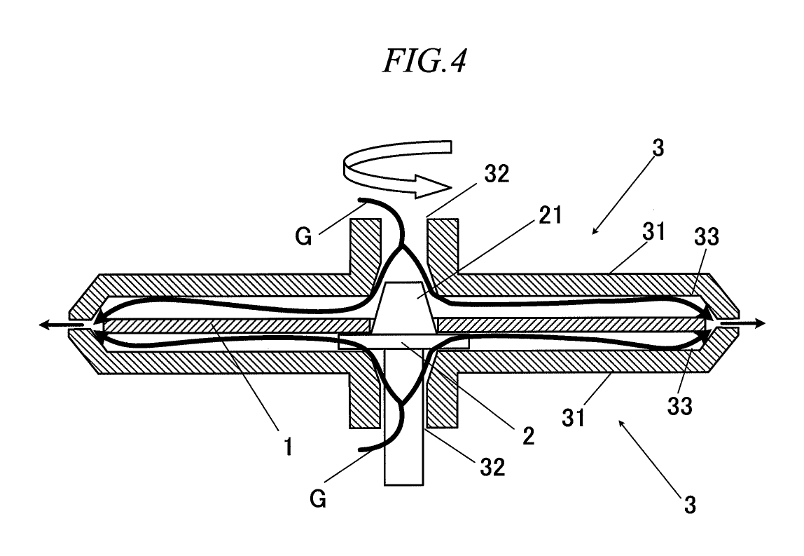

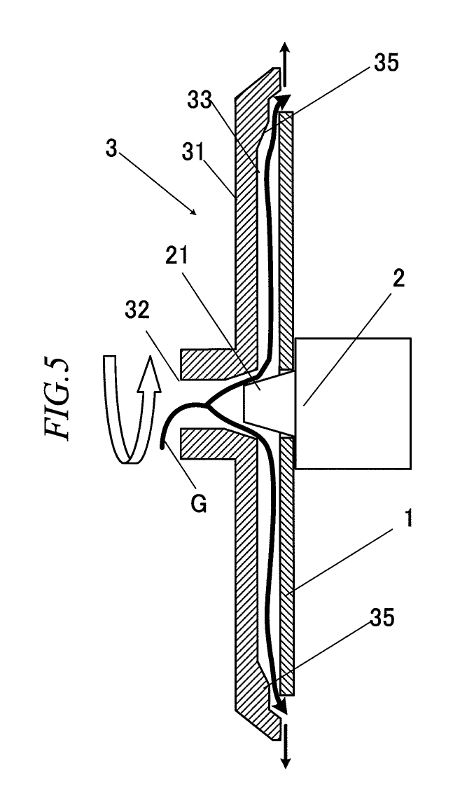

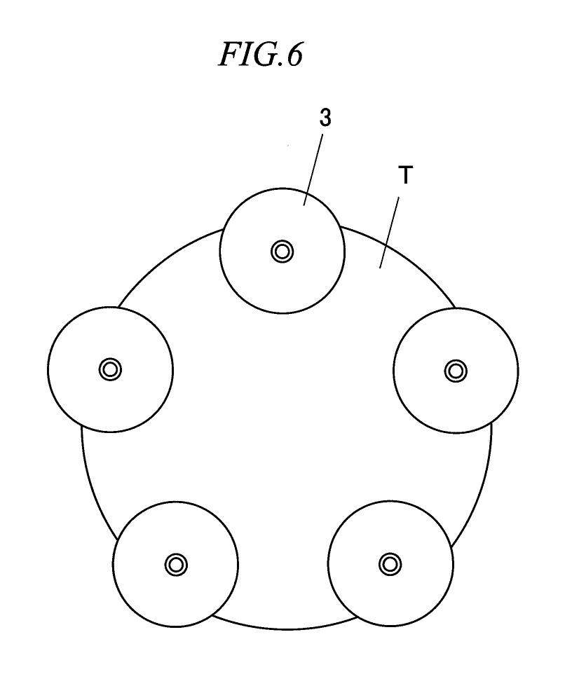

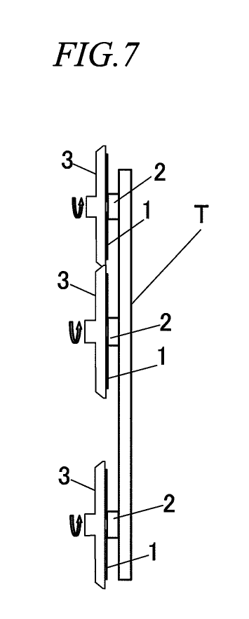

The present invention is not limited to the embodiment as described above. For example, a pair of flow rectification portions 3 may be provided as shown in FIG. 4, covering both sides of the substrate 1. In this way, it is possible to uniformly cool the substrate 1 from both sides. The number of substrates processed at the same time is also not limited to the number shown in the example of the embodiment described above. In other words, the number of holding portions and flow rectification portions installed is not limited, and there may be one or there may be many. For example, as shown in FIG. 5, there may be just one set of holding portion 2 and flow rectification portion 3, without providing a cooling chamber. Also, as shown in FIGS. 6 and 7, a plurality of sets of holding portion 2 and flow rectification portion 3 may be provided on a turntable T.

In locations where the gap between the surface of the facing portion and the surface of the substrate becomes narrow, the flow speed increases due to the Venturi effect. In particular, as shown in FIGS. 1 and 4, gas molecules on the surface of the facing portion 33 are drawn in by the rotation of the plate 31, causing a spiral-shaped flow towards the outer periphery, furthermore near the perimeter the gap with the substrate 1 becomes narrower (see FIGS. 1 and 4), so as a result of the Venturi effect due to the gas flow past the exit, which is narrower than the inlet, the flow speed increases, which promotes the process. In order to positively utilize the Venturi effect, a projecting portion 35 that narrows the gap with the substrate 1 may be provided near the perimeter of the facing portion 33, as shown in FIG. 5, made either continuous in a ring shape, or a plurality of projecting portions 35 may be provided at predetermined intervals.

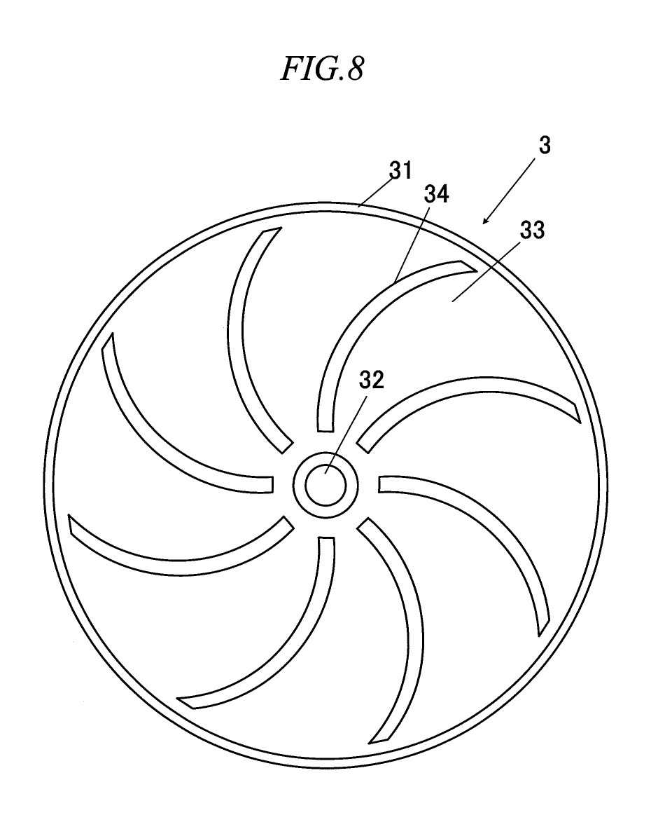

Also, in the embodiment described above, fins are formed in the facing portion, however any shape may be used provided the cooling gas can be made to flow across the surface of the substrate. The number of fins is not limited. For example, radiating grooves may be provided, or concentric circular projections or grooves, or spiral shaped projections or grooves may be provided. As shown in FIG. 8, fins shaped like an involute pump may be provided, to promote gas flow. The projections may have a flat plate shape, or be shaped like projections, the grooves may be depressions or holes. The surface of the facing portion may be processed to be rough or undulating. Further, the flow rectification portion does not necessarily have to be rotated. Provided the cooling gas is introduced into the inlet portion 32 and a gas flow is created, the facing portion may be stationary, and the effect of the cooling gas uniformly flowing over the surface will be obtained.

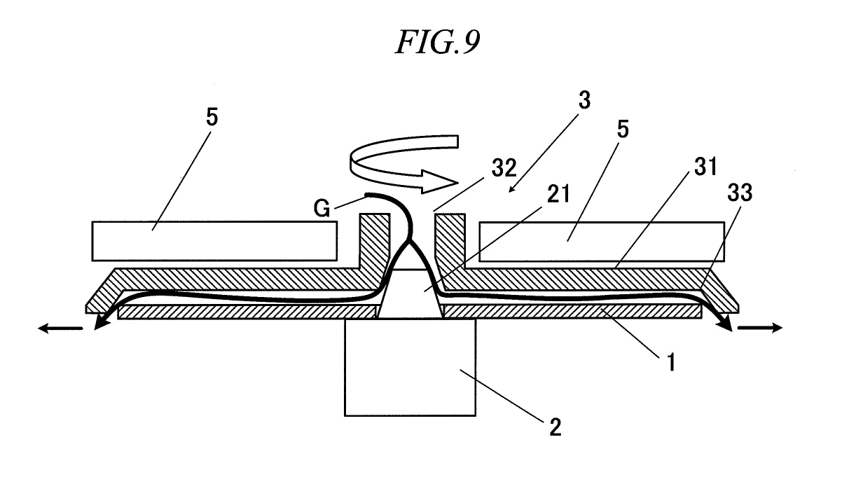

Also, as shown in FIG. 9, the cooling effect may be increased by providing a cooling device 5 near the flow rectification portion 3, and cooling the plate 31 itself. A cooling device may also be provided in the plate itself. Also, various types of inactive gas, air, or the like may be considered as the cooling gas, but there is no particular limitation.

Furthermore, the process applied to the substrate is not limited to cooling, and there is freedom regarding the medium that is introduced. For example, the substrate maybe uniformly heated by introducing heated gas, or the substrate may be uniformly decharged by introducing ion gas. Corresponding to this, the cooling device 5 in FIG. 9 may be a heating device that is capable of increasing the heating capacity. A heating device may be provided in the plate itself.

An application for heating in this way is for a drying process. For example, if the present invention is applied to drying a pigment that is spin applied to the substrate, by using either one or both of the heating gas and the heating device, deformation of the substrate is prevented, the same as for cooling, each substrate can be uniformly processed without variation, and the drying time can be reduced.

There is also freedom regarding the size, shape, material, and so on, of the substrate, and all types of conventional substrate may be used. Therefore, not only discs for recording media, but also all types of substrate, such as substrates for liquid crystals or organic EL, and so on, may be used. In other words, “substrate” as stated in the claims is not limited to circular discs or the like, but flat plane shaped products are broadly included in the concept. Therefore, the method of holding by the holding portion is not limited to the format of holding via a center hole, and formats in which one side is held by suction, or held at the edge may be used.

1. A substrate processing apparatus, comprising:
a holding portion that holds a substrate; and
a flow rectification portion disposed near the substrate that is held by the holding portion, wherein
the flow rectification portion has a facing portion opposed to and close to at least one side of the substrate, and an inlet portion that introduces a medium for processing between the substrate, which is held by the holding portion so as to not rotate, and the facing portion.

2. The substrate processing apparatus according to claim 1, wherein the flow rectification portion has a drive unit that rotates the facing portion.

3. The substrate processing apparatus according to claim 1, wherein projections or grooves are formed in the facing portion.

4. The substrate processing apparatus according to claim 1, wherein the facing portion is disposed on both sides of the substrate.

5. The substrate processing apparatus according to claim 1, wherein the facing portion is provided with a projecting portion near the peripheral edge of the substrate to narrow the gap with the substrate.

6. The substrate processing apparatus according to claim 1, wherein a cooling device is provided on the flow rectification portion to cool the facing portion.

7. The substrate processing apparatus according to claim 1, wherein a heating device is provided on the flow rectification portion to heat the facing portion.
